(19) United States
(12) Patent Application Publication
(10) Pub. No.: US 2026/0024901 A1
(43) Pub. Date: Jan. 22, 2026

(54) BATTERY PACK TERMINAL SHIELD ASSEMBLY

(71) Applicant: Ford Global Technologies, LLC, Dearborn, MI (US)

(72) Inventors: Yongcai Wang, Ann Arbor, MI (US); Frank Kim, South Lyon, MI (US); Brian Utley, Canton, MI (US); Kwon Shon, Troy, MI (US); Jerry Lan, Ann Arbor, MI (US); Chi Paik, Grosse Ile, MI (US)

(21) Appl. No.: 18/775,408

(22) Filed: Jul. 17, 2024

(51) Int. Cl. H01M 50/591; H01M 50/249; H01M 50/55

(52) U.S. Cl. CPC H01M 50/591; H01M 50/249; H01M 50/55

(57) ABSTRACT

A battery pack terminal shield assembly includes an anchoring section, a first terminal cap connected to the anchoring section, and a second terminal cap connected to the anchoring section. The anchoring section is configured to secure the first terminal cap and the second terminal cap relative to an array of traction battery pack.

### TECHNICAL FIELD

This disclosure relates generally to caps for shielding terminals of a traction battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack terminal shield assembly, including: an anchoring section; a first terminal cap connected to the anchoring section; and a second terminal cap connected to the anchoring section, the anchoring section configured to secure the first terminal cap and the second terminal cap relative to an array of traction battery pack.

In some aspects, the techniques described herein relate to a traction battery pack terminal shield assembly, wherein, when the anchoring section is secured relative to the array, the first terminal cap is movable back and forth between a first terminal covering position and a first terminal accessing position.

In some aspects, the techniques described herein relate to a traction battery pack terminal shield assembly, wherein, when the anchoring section is secured relative to the array, the second terminal cap is movable back and forth between a second terminal covering position and a second terminal accessing position.

In some aspects, the techniques described herein relate to a traction battery pack terminal shield assembly, wherein the first terminal cap in the first terminal covering position covers a positive terminal of a battery array, wherein the second terminal cap in the second terminal covering position covers a negative terminal of a battery array.

In some aspects, the techniques described herein relate to a traction battery pack terminal shield assembly, wherein the first terminal cap engages a first grommet when the first terminal cap is in the first terminal covering position, wherein the second terminal cap engages a second grommet when the second terminal cap is in the second terminal covering position,

In some aspects, the techniques described herein relate to a traction battery pack terminal shield assembly, wherein the first terminal cap engages the first grommet through a snap-fit connection when the first terminal cap is in the first terminal covering position.

In some aspects, the techniques described herein relate to a traction battery pack terminal shield assembly, further including at least one retention system configured to hold the first terminal cap in a first terminal accessing position, the second terminal cap in a second terminal accessing position, or both.

In some aspects, the techniques described herein relate to a traction battery pack terminal shield assembly, wherein the at least one retention system includes a first hook projecting from the anchoring section, and a second hook projecting from the anchoring section, the first hook configured to hold the first terminal cap in the first terminal accessing position, the second hook configured to hold the second terminal cap in the second terminal accessing position.

In some aspects, the techniques described herein relate to a traction battery pack terminal shield assembly, wherein the at least one retention system includes a first post held within a first aperture to hold the first terminal cap in the first terminal accessing position, and a second post held within a second aperture to hold the second terminal cap in the second terminal accessing position.

In some aspects, the techniques described herein relate to a traction battery pack terminal shield assembly, wherein the first post and the second post extend from the anchoring section.

In some aspects, the techniques described herein relate to a traction battery pack terminal shield assembly, further including a first swing tether hinge connecting the first terminal cap to the anchoring section, and a second swing tether hinge connecting the second terminal cap to the anchoring section.

In some aspects, the techniques described herein relate to a traction battery pack terminal shield assembly, wherein the anchoring section is secured to the array with at least one mechanical fastener.

In some aspects, the techniques described herein relate to a traction battery pack terminal shield assembly, wherein the anchoring section, the first terminal cap, and the second terminal cap are a polymer-based material.

In some aspects, the techniques described herein relate to a traction battery pack terminal shield assembly, wherein the anchoring section, the first terminal cap, and the second terminal cap are a rubber material.

In some aspects, the techniques described herein relate to a traction battery pack assembly, including: a plurality of battery cells held within an array enclosure; a first array terminal; a second array terminal; and a traction battery pack shield assembly having both a first terminal cap and a second terminal cap, the first terminal cap movable back and forth between a first terminal covering position and a first terminal accessing position, the second terminal cap movable back and forth between a second terminal covering position and a second terminal accessing position.

In some aspects, the techniques described herein relate to a traction battery pack assembly, wherein the first array terminal is a positive array terminal, and the second array terminal is a negative array terminal.

In some aspects, the techniques described herein relate to a traction battery pack assembly, wherein the first terminal cap is snap-fit to a first grommet when the first terminal cap is in the first terminal covering position, and the second terminal cap is snap-fit to a second grommet when the second terminal cap is in the second terminal covering position.

In some aspects, the techniques described herein relate to a traction battery pack assembly, wherein the first terminal cap is movable back and forth between the first terminal covering position and the first terminal accessing position while the second terminal cap remains in the second terminal covering position.

In some aspects, the techniques described herein relate to a traction battery pack assembly, wherein the plurality of battery cells are battery cells of traction battery pack of an electrified vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective and view of a traction battery pack from the electrified vehicle of FIG. 1 according to an exemplary embodiment of the present disclosure with selected portions expanded and cutaway to show details of the traction battery pack.

FIG. 3 illustrates a close up view of a terminal shield assembly and surrounding areas within the battery pack of FIG. 2 when terminal caps of the terminal shield assembly are in terminal covering positions.

FIG. 4 illustrates the terminal shield assembly and surrounding area of FIG. 3 with one terminal cap of the terminal shield assembly in a terminal accessing position and one terminal cap of the terminal shield assembly in the terminal covering position.

FIG. 5 illustrates a perspective view of a terminal shield assembly according to another exemplary aspect of the present disclosure.

### DETAILED DESCRIPTION

This disclosure details a terminal shield assembly having terminal caps that can cover respective terminals in a battery pack.

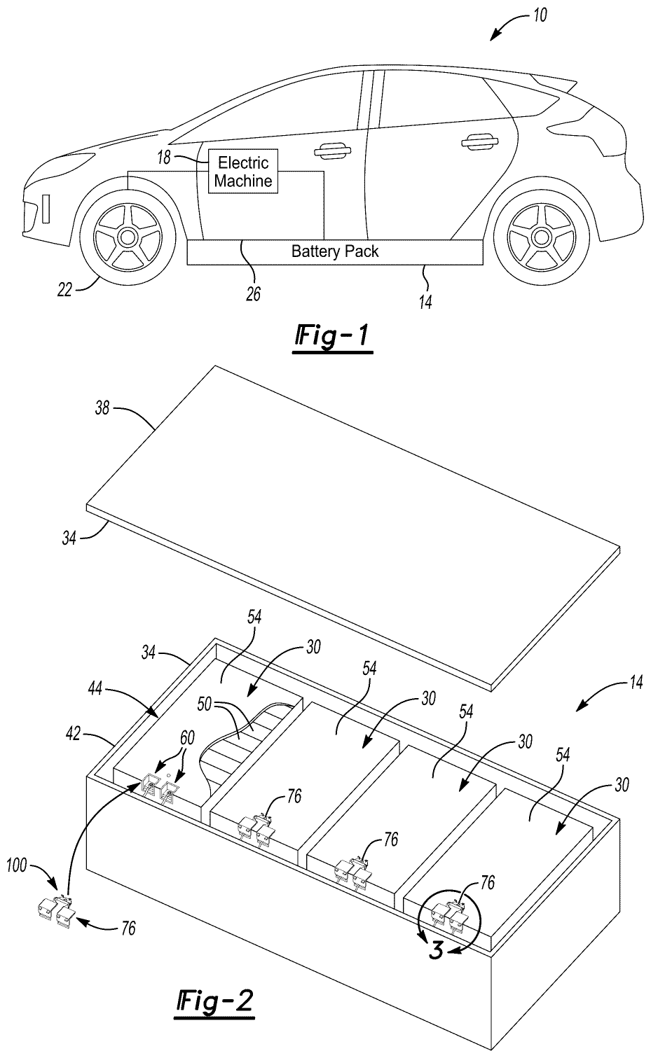

With reference to FIG. 1, an electrified vehicle 10 includes a traction battery pack 14, an electric machine 18, and wheels 22. The battery pack 14 powers the electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

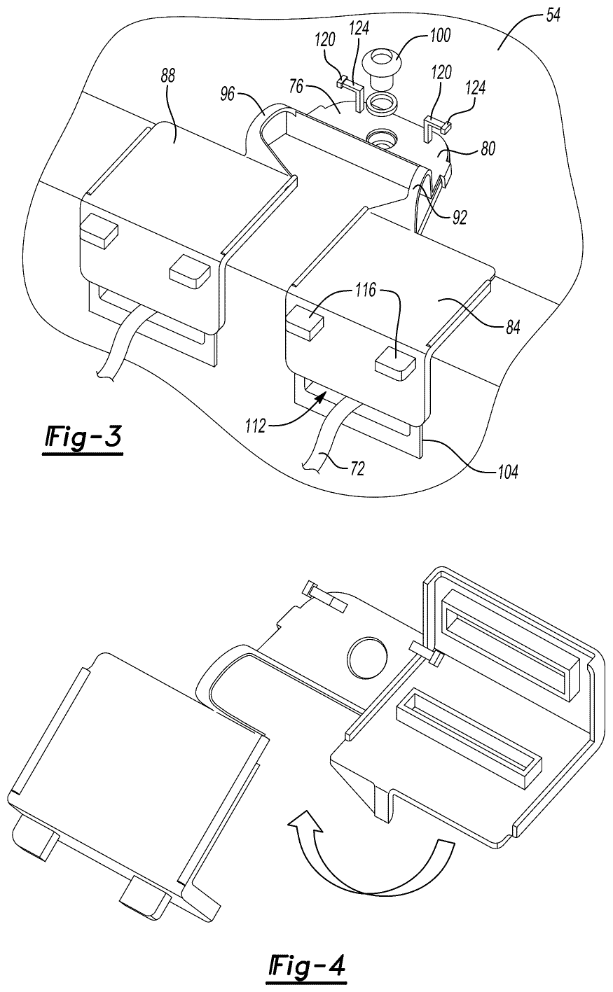

With reference now to FIG. 2, the battery pack 14 includes a plurality of battery arrays 30 held within a battery pack enclosure 34. In the exemplary embodiment, the enclosure 34 includes an enclosure cover 38 and an enclosure tray 42. The enclosure cover 38 is secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes a plurality of battery cells 50 (or simply, “cells”) held within an array housing 54. The battery cells 50 store and supply electrical power. In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

Although specific numbers of the battery arrays 30 and cells 50 are illustrated in the various figures of this disclosure, the battery pack 14 could include any number of the battery arrays 30 having any number of individual cells 50.

With reference now to FIGS. 3 and 4 and continuing reference to FIG. 2, the battery arrays 30 each include array terminals 60, which provide an interface for electrically coupling a given one of the battery arrays 30 to a device external to that battery array 30. Each example battery array 30 includes two array terminals 60-a positive terminal and a negative terminal. Other example arrays could include other numbers of terminals.

In this example, a lug 64 can be secured to each terminal 60 with a fastener 68. The lug 64, when secured, couples an electrical cable 72 to the terminal 60 so that electrical current can flow to and from the battery array 30 through the terminals 60.

Each array 30 includes a terminal shield assembly 76 that is used to cover the array terminals 60 when access to the array terminals 60 is not required. The terminal shield assembly 76 can help to guard against inadvertent contact with the terminals 60. For example, the terminal shield assemblies 76 can guard against the array terminals 60 being inadvertently contacted when a technician is servicing the battery pack 14.

The terminal shield assembly 76, in the exemplary embodiment, includes an anchoring section 80, a first terminal cap 84, and a second terminal cap 88. The first terminal cap 84 is connected to the anchoring section 80 with a first swing tether hinge 92. The second terminal cap 88 is connected to the anchoring section 80 with a second swing tether hinge 96.

The terminal shield assembly 76 is a dielectric material. The terminal shield assembly 76 can be a polymer-based material, such as a rubber material.

The anchoring section 80, the first terminal cap 84, the second terminal cap 88, the first swing tether hinge 92, and the second swing tether hinge 96 are formed together as a single monolithic component. This can reduce build complexity when compared to a design having terminal caps that are separate from each other.

The anchoring section 80 is, in this example, secured to the array housing 54 with a mechanical fastener 100. When the anchoring section 80 is secured to the array housing 54, the first terminal cap 84 and the second terminal cap 88 are each independently movable back and forth between a terminal covering position and a terminal accessing position. The first swing tether hinge 92 and the second swing tether hinge 96 permit this movement. The anchoring section 80 secures the entire terminal shield assembly 76 relative to the array 30.

When the first terminal cap 84 is in the terminal covering position, the first terminal cap 84 engages a first grommet 104 of the array housing 54. The first terminal cap 84 can include snap fit features 108 that allow the first terminal cap 84 to snap-fit to the first grommet 104 when in the terminal covering position. When the first terminal cap 84 is in the terminal covering position, a passage 112 is provided between the first grommet 104 and the first terminal cap 84. The passage 112 permits the cable 72 to extend to the lug 64 that is connected to the respective terminal 60.

The first terminal cap 84 includes at least one pull tab 116. When access to the terminal 60 covered by the first terminal cap 84 is required and the first terminal cap 84 is in the terminal covering position, a user can pull on the at least one pull tab 116 to disengage the first terminal cap 84 from the first grommet 104 and to move the first terminal cap 84 to the terminal accessing position.

The example anchoring section 80 includes a retention system having at least one retention feature 120. After the user moves the first terminal cap 84 to the terminal accessing position, the user can engage the first terminal cap 84 with the at least one retention feature 120 to hold the first terminal cap 84 in the terminal accessing position. The user can then, as required, access the respective terminal 60 and areas surrounding the terminal 60 without interference from the first terminal cap 84.

In this example, the at least one retention feature 120 includes a hook 124 projecting from the anchoring section 80. The user can place the first swing tether hinge 92, the first terminal cap 84, or both, beneath the hook 124 to hold the first terminal cap 84 in the terminal accessing position.

The second terminal cap 88 can be moved back and forth between the terminal covering position and the terminal accessing position similarly to the first terminal cap 84. The second terminal cap 88 engages a second grommet 128 when the second terminal cap is in the terminal covering position.

The first grommet 104 and the second grommet 128 can be made of a dielectric material. The first grommet 104 and the second grommet 128 are rubber in this example.

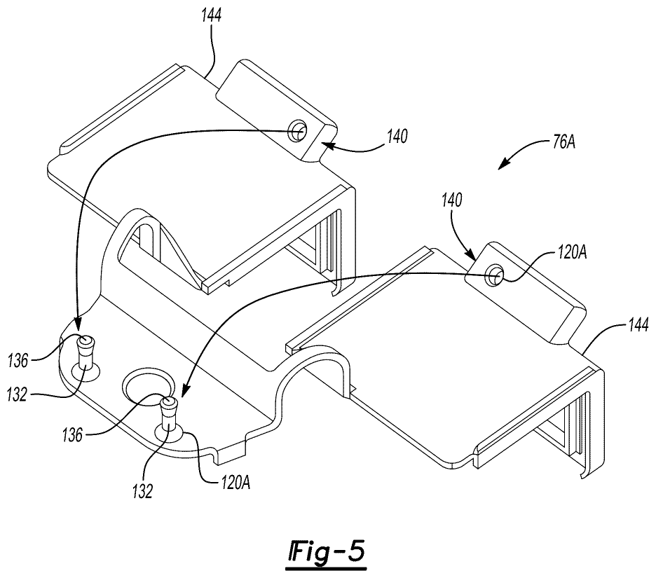

With reference to FIG. 5, another example terminal shield assembly 76A includes at least one retention feature 120A having at least one post 132 and a corresponding aperture 140. The at least one post 132 has an enlarged head 136. The at least one post 132 is received within the corresponding aperture 140 to hold an associated terminal cap 144 in a terminal accessing position. The enlarged head 136 inhibits withdrawal of the post 132 from within the aperture 140.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack terminal shield assembly, comprising:
an anchoring section;
a first terminal cap connected to the anchoring section; and
a second terminal cap connected to the anchoring section, the anchoring section configured to secure the first terminal cap and the second terminal cap relative to an array of traction battery pack.

2. The traction battery pack terminal shield assembly of claim 1, wherein, when the anchoring section is secured relative to the array, the first terminal cap is movable back and forth between a first terminal covering position and a first terminal accessing position.

3. The traction battery pack terminal shield assembly of claim 2, wherein, when the anchoring section is secured relative to the array, the second terminal cap is movable back and forth between a second terminal covering position and a second terminal accessing position.

4. The traction battery pack terminal shield assembly of claim 3, wherein the first terminal cap in the first terminal covering position covers a positive terminal of a battery array, wherein the second terminal cap in the second terminal covering position covers a negative terminal of a battery array.

5. The traction battery pack terminal shield assembly of claim 3, wherein the first terminal cap engages a first grommet when the first terminal cap is in the first terminal covering position, wherein the second terminal cap engages a second grommet when the second terminal cap is in the second terminal covering position.

6. The traction battery pack terminal shield assembly of claim 5, wherein the first terminal cap engages the first grommet through a snap-fit connection when the first terminal cap is in the first terminal covering position.

7. The traction battery pack terminal shield assembly of claim 1, further comprising at least one retention system configured to hold the first terminal cap in a first terminal accessing position, the second terminal cap in a second terminal accessing position, or both.

8. The traction battery pack terminal shield assembly of claim 7, wherein the at least one retention system comprises a first hook projecting from the anchoring section, and a second hook projecting from the anchoring section, the first hook configured to hold the first terminal cap in the first terminal accessing position, the second hook configured to hold the second terminal cap in the second terminal accessing position.

9. The traction battery pack terminal shield assembly of claim 7, wherein the at least one retention system comprises a first post held within a first aperture to hold the first terminal cap in the first terminal accessing position, and a second post held within a second aperture to hold the second terminal cap in the second terminal accessing position.

10. The traction battery pack terminal shield assembly of claim 9, wherein the first post and the second post extend from the anchoring section.

11. The traction battery pack terminal shield assembly of claim 1, further comprising a first swing tether hinge connecting the first terminal cap to the anchoring section, and a second swing tether hinge connecting the second terminal cap to the anchoring section.

12. The traction battery pack terminal shield assembly of claim 1, wherein the anchoring section is secured to the array with at least one mechanical fastener.

13. The traction battery pack terminal shield assembly of claim 1, wherein the anchoring section, the first terminal cap, and the second terminal cap are a polymer-based material.

14. The traction battery pack terminal shield assembly of claim 1, wherein the anchoring section, the first terminal cap, and the second terminal cap are a rubber material.

15. A traction battery pack assembly, comprising:
a plurality of battery cells held within an array enclosure;
a first array terminal;
a second array terminal; and
a traction battery pack shield assembly having both a first terminal cap and a second terminal cap, the first terminal cap movable back and forth between a first terminal covering position and a first terminal accessing position, the second terminal cap movable back and forth between a second terminal covering position and a second terminal accessing position.

16. The traction battery pack assembly of claim 15, wherein the first array terminal is a positive array terminal, and the second array terminal is a negative array terminal.

17. The traction battery pack assembly of claim 15, wherein the first terminal cap is snap-fit to a first grommet when the first terminal cap is in the first terminal covering position, and the second terminal cap is snap-fit to a second grommet when the second terminal cap is in the second terminal covering position.

18. The traction battery pack assembly of claim 15, wherein the first terminal cap is movable back and forth between the first terminal covering position and the first terminal accessing position while the second terminal cap remains in the second terminal covering position.

19. The traction battery pack assembly of claim 15, wherein the plurality of battery cells are battery cells of traction battery pack of an electrified vehicle.
